(19) United States
(12) Patent Application Publication
(10) Pub. No.: US 2014/0330414 A1
(43) Pub. Date: Nov. 6, 2014

(54) SYSTEM OF AN INTERNET INTERACTIVE SERVICE AND OPERATING METHOD THEREOF

(71) Applicant: IKALA INTERACTIVE MEDIA INC., Taipei City (TW)

(72) Inventors: TSE-MING CHANG, Taipei City (TW); SHIH-CHIA CHENG, Taipei City (TW); KAI-YIN CHENG, Taipei City (TW); YU-HSIANG LIN, Taipei City (TW)

(21) Appl. No.: 13/939,179

(22) Filed: Jul. 10, 2013

(30) Foreign Application Priority Data
May 3, 2013 (TW) 102115914

(51) Int. Cl. G10L 19/018

(52) U.S. Cl. CPC G10L 19/018
USPC 700/94

(57) ABSTRACT

A system of an internet interactive service and operating method thereof is disclosed. A network host is to transmit an audio watermark not only to connect with multiple devices but also to set the multiple devices as a specific group. The invention comprises following steps: connecting at least one multimedia device with the network host, transmitting the audio watermark which may comprise certification from the network host to the at least one multimedia device, the at least one multimedia device broadcasting the audio watermark, the at least one electronic device receiving the audio watermark and afterward transmitting the audio watermark or the certification to the network host, the network host recognizing the audio watermark or the certification and afterward setting the at least one multimedia device and the at least one electronic device as the specific group, transmitting at least one datum from the network host to the specific group.

### BACKGROUND OF THE INVENTION

1. Field of the Invention

This present invention relates to a system of an internet interactive service and operating method thereof, more particularly to a method of utilizing a network host to transmit an audio watermark not only to connect with multiple devices but also to set the multiple devices as a specific group in which the network host can transmit at least one datum to the multiple devices.

2. Description of the Prior Arts

An audio watermark is usually applied in the transmission of data between two devices, such as between a television and a portable device or between a radio system and the portable device.

Taking the Antiques Roadshow for example, the Antiques Roadshow is a TV program broadcasted by British Broadcasting Corporation (BBC), the television broadcasts an audio embedded with the audio watermark from the Antique Roadshow. A user can use the portable device installed with specific application software to identify the audio watermark and therefore distinguish an episode or a time slot of the Antique Roadshow. As the episode or the time slot of the Antique Roadshow is identified, the user may guess a price of an antique introduced by an antique connoisseur in the TV program, afterward; the antique connoisseur gives a correct answer to the price of the antique and the specific application software subsequently ranks the user a novice or an expert according to the precision of the user's guess.

As another example in the radio system, a radio broadcasts a radio signal embedded with the audio watermark comprising a specific time slot signal of a radio broadcast program. The user can use the portable device installed with another specific application software to read the specific time slot signal comprised in the audio watermark, and the user can decide whether to download the radio broadcast program.

In the example of the Antiques Roadshow, the audio watermark is used as a tool for being distinguished an episode or a time slot of the TV program. Though the user may interact with the Antiques Roadshow via the specific application software installed in the portable device, programs in the Antiques Roadshow are pre-recorded, and the user may feel bored to the have-nothing-new-or-unusual interaction as time goes by.

The audio watermark in the radio system is used as a tool for unilateral data transmission. The radio broadcasts the audio watermark comprised a specific message to the portable device installed with particular application software, and the portable device can utilize the particular application software to identify or read the specific message comprised in the audio watermark. After the portable device acquires the specific message, two devices proceed no further interaction, which lacks entertainment for the users. Besides, practicability of unilateral data transmission is insufficient for a great deal of information tasks are waited to be carried out in the present days.

### SUMMARY OF THE INVENTION

In order to solve drawbacks of fixed interaction and unilateral data transmission, the invention proposes a system of an internet interactive service and operating method thereof. The invention utilizes a network host to transmit an audio watermark not only to connect with at least one multimedia device and at least one electronic device but also to set the at least one multimedia device and the at least one electronic device as a specific group. The network host can further transmit at least one datum to the specific group comprising the at least one multimedia device, the at least one electronic device, or the combination thereof.

The at least one multimedia device of the invention comprises a first network interface, a multimedia device microprocessor and an audio broadcasting system. The at least one multimedia device can connect to internet via the first network interface. The multimedia device microprocessor is connected with the first network interface and the audio broadcasting system. The audio broadcasting system can broadcast an audio watermark which may comprise certification.

The at least one electronic device of the invention comprises a third network interface, an electronic device microprocessor and an audio receiving system. The at least one electronic device can connect to internet via the third network interface. The electronic device microprocessor is connected with the third network interface and the audio receiving system. The audio receiving system can receive the audio watermark.

The network host of the invention comprises a second network interface, a network host central processor, a storage system and a recognition system. The second network interface is connected with the network host central processor and the storage system. The second network interface can connect to the first network interface of the at least one multimedia device and the third network interface of the at least one electronic device via internet. The storage system storing the at least one datum is connected with the network host central processor and the second internet interface. The recognition system is connected with the network host central processor. The recognition system can recognize that the audio watermark broadcast by the at least one multimedia device is the same as the audio watermark received by the at least one electronic device.

The audio watermark is transmitted from the storage system of the network host via the second network interface to the at least one multimedia device. The audio broadcasting system of the at least one multimedia device broadcasts the audio watermark to the audio receiving system of the at least one electronic device, and afterward, the at least one electronic device transmits the audio watermark or the certification via the third network interface to the network host. The network host utilizes the recognition system to recognize that the audio watermark or the certification transmitted by the at least one electronic device is the same as the audio watermark transmitted from the network host to the at least one multimedia device. The network host further sets the at least one multimedia device and the at least one electronic device as the specific group and transmits the at least one datum via the second network interface to the specific group comprising the at least one multimedia device, the at least one electronic device, or the combination thereof. The at least one datum can be the sound watermark, the certification, a text, a file, a video, an audio, multimedia, software for processing a specific work comprising video-editing software, audio-editing software, real-time communication software, motion sensing producing software, voting system software, advertising system software, an electronic game, teaching and research software, monitoring system software, payment system software, remote control system software, or the combination thereof.

The at least one multimedia device can be a television, a smartphone, a computer or a tablet computer, and the at least one electronic device can be a television, a smartphone, a computer or a tablet computer. Through communication software, the computer can invite the smartphone to join the electronic game, and by using the invention, the computer and the smartphone can be set as the specific group. Afterward, users of the computer and the smartphone can play the electronic game producing motion sensing together. When the computer performs an action in the electronic game, the smartphone performs motion sensing in response, and vice versa. Likewise, the computer can broadcasts the audio watermark through an on-line karaoke system, the smartphone can receive the audio watermark, and afterward, the computer and the smartphone can be set as the specific group via the network host. Therefore, the smartphone is joined the on-line karaoke system and can use the on-line karaoke system with the computer simultaneously. The users of the computer and the smartphone can sing together through the on-line karaoke system.

The invention utilizes the audio watermark to connect the at least one multimedia device with the at least one electronic device and to set the at least one multimedia device and the at least one electronic device as the specific group. Afterwards, the network host transmits the at least one datum to the specific group comprising the at least one multimedia device, the at least one electronic device, or the combination thereof. The at least one multimedia device and the at least one electronic device can interact through the at least one datum. Consequently, the system of the internet interactive service and operating method thereof not merely solves drawbacks of fixed interaction and unilateral data transmission but provides real-time and various interaction by setting devices as the specific group via internet through the audio watermark of the invention and transmitting the at least one datum to the specific group.

### BRIEF DESCRIPTION OF THE DRAWINGS

FIG. 1 illustrates a flowchart of the invention.

FIG. 2 illustrates a system framework of this invention.

### DETAILED DESCRIPTION OF THE INVENTION

Hereinafter, embodiments of this invention will be explained in detail with reference to the drawings; however, this invention is not limited thereto.

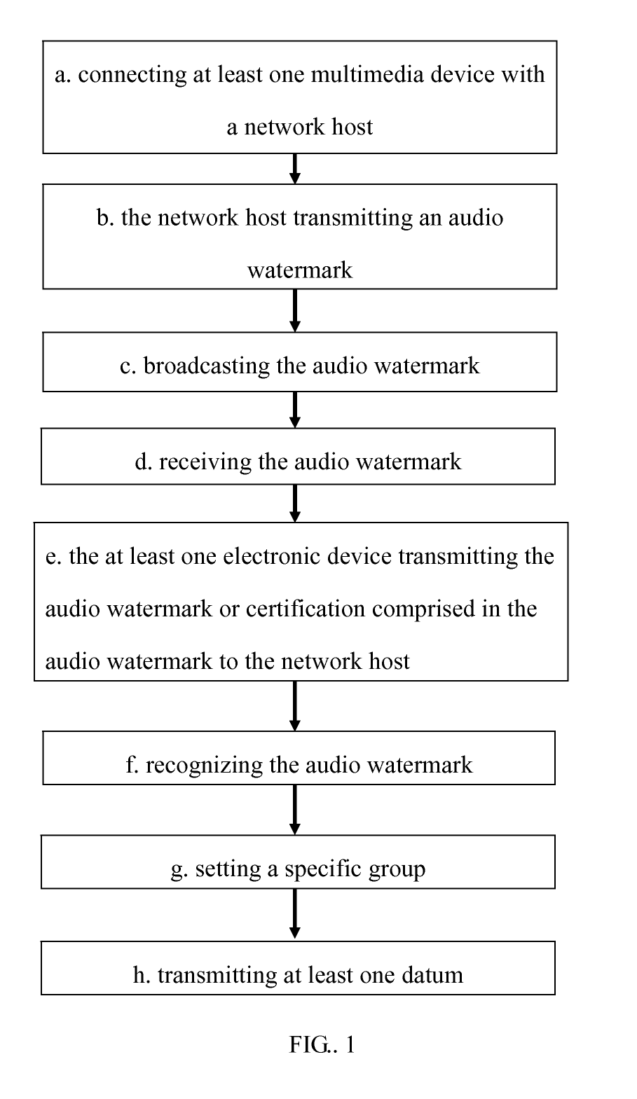

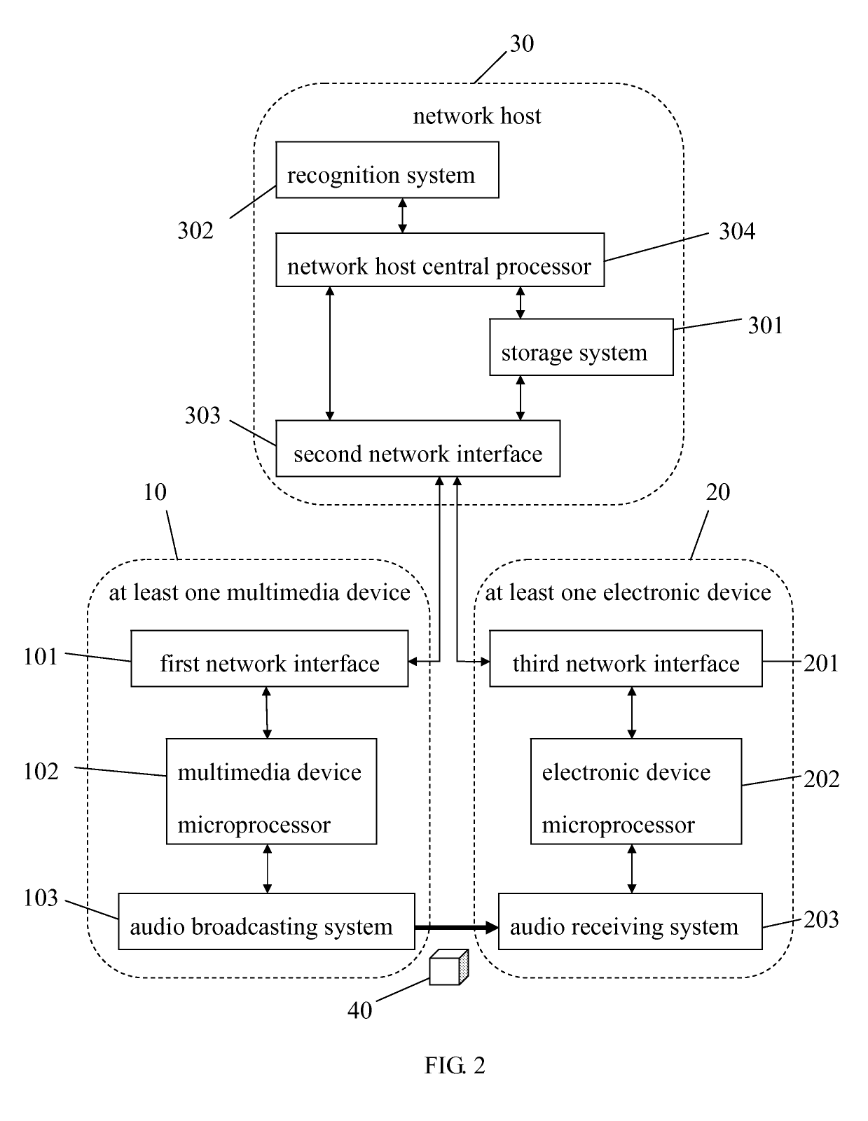

Referring to FIG. 1 and FIG. 2, an operating method for a system of an internet interactive service comprising a network host 30, at least one multimedia device 10 and at least one electronic device 20 comprises following steps:
a. connecting a first network interface 101 of the at least one multimedia device 10 with a second network interface 303 of the network host 30,
b. the network host 30 transmitting an audio watermark 40,
the network host 30 comprising a storage system 301 and a recognition system 302, the audio watermark 40 which may comprising certification stored in the storage system 301, the network host 30 transmitting the audio watermark 40 via the second network interface 303 to the at least one multimedia device 10,
c. broadcasting the audio watermark 40,
the at least one multimedia device 10 broadcasting the audio watermark 40 via an audio broadcasting system 103 which can be a speaker,
d. receiving the audio watermark 40,
the at least one electronic device 20 receiving the audio watermark 40 via an audio receiving system 203 which can be a microphone or a receiving set,
e. the at least one electronic device 20 transmitting the audio watermark 40 or the certification via a third network interface 201 to the network host 30,
f. recognizing the audio watermark 40,
the recognition system 302 of the network host 30 recognizing the audio watermark 40 or the certification transmitted by the at least one electronic device 20 the same as the audio watermark 40 transmitted from the network host 30 to the at least one multimedia device 10,
g. setting a specific group,
the network host 30 setting the at least one multimedia device 10 and the at least one electronic device 20 as the specific group,
h. transmitting at least one datum,
the network host 30 transmitting at least one datum to the specific group comprising the at least one multimedia device 10, the at least one electronic device 20, or the combination thereof.

Suppose the audio watermark 40 in the step b comprises the certification. The at least one electronic device 20 in the step e may choose the audio watermark 40 or the certification to transmit via the third network interface 201 to the network host 30. Afterwards, the recognition system 302 in the step f may recognize that the audio watermark 40 or the certification transmitted by the at least one electronic device 20 is the same as the audio watermark 40 transmitted from the network host 30 to the at least one multimedia device 10. Suppose the audio watermark 40 in the step b does not comprise the certification. The at least one electronic device 20 in the step e transmits only the audio watermark 40 via the third network interface 201 to the network host 30. Afterwards, the recognition system 302 in the step f recognizes only the audio watermark 40 transmitted by the at least one electronic device 20 the same as the audio watermark 40 transmitted from the network host 30 to the at least one multimedia device 10.

The invention can utilize a computer as the at least one multimedia device 10, a smartphone as the at least one electronic device 20 and the network host 30. After the computer connects to the network host 30 via internet, the network host 30 transmits the audio watermark 40 to the computer. Afterward, the computer broadcasts the audio watermark 40 via the speaker to the smartphone. Once the microphone of the smartphone receives the audio watermark 40, the smartphone transmits the audio watermark 40 or the certification to the network host 30. After the network host 30 recognizes the audio watermark 40 or the certification, the network host 30 sets the computer and the smartphone as the specific group. Afterward, the network host 30 transmits the at least one datum to the specific group so that the computer and the smartphone can interact through the at least one datum.

A data storage device of the storage system 301 can be Redundant Array of Inexpensive Disks (RAID), Solid State Disk (SSD), Hard Disk Drive (HDD), a memory, a magnetic tape, Network Attached Storage (NAS), or the combination thereof. The RAID is a fault tolerant or non-fault tolerant array system consisting of a plurality of hard disk drives. Utilizing at least one SSD, at least one HDD, or the combination thereof can form one or more physical hard disks. The memory made by semiconductor technology is an electronic element which can store data. The magnetic tape made of a thin magnetizable coating on a long and narrow strip of a plastic film is a non-volatile recording medium. The NAS utilizes at least one HDD set up in a local area network for the network host 30 to equip with larger capacity without processing data at the same time.

Computing architecture of the network host 30 can be centralized computing or distributed computing. In distributed computing, data is divided into many tasks, each of which is solved by one or more network host 30 communicating with each other by message passing. In centralized computing, one network host 30 processes all tasks.

The network host 30 can be a pedestal server, a rack server, a mainframe computer, a super computer or a blade server. The pedestal server is a desktop comprising multiple expansion slots. The rack server is a small horizontal type host computer for making good use of space. The mainframe computer used for processing a great quantity of data is a development of basic design from IBM System/360 compatible computers. The super computer is a computer equipping extra-large processing capacity and high speed of calculation. The blade server is a large machine box comprising multiple independent server modules.

What is claimed is:

1. An operating method for a system of an internet interactive service comprising a network host, at least one multimedia device and at least one electronic device comprises following steps:
a. connecting at least one multimedia device with a network host;
b. the network host transmitting an audio watermark, the network host transmitting the audio watermark to the at least one multimedia device;
c. broadcasting the audio watermark, the at least one multimedia device broadcasting the audio watermark to at least one electronic device;
d. receiving the audio watermark, the at least one electronic device receiving the audio watermark;
e. the at least one electronic device transmitting the audio watermark or certification comprised in the audio watermark to the network host;
f. recognizing the audio watermark, the network host recognizing the audio watermark or the certification transmitted by the at least one electronic device the same as the audio watermark transmitted from the network host to the at least one multimedia device;
g. setting a specific group, the network host setting the at least one multimedia device and the at least one electronic device as the specific group; and
h. transmitting at least one datum, the network host transmitting the at least one datum to the specific group comprising the at least one multimedia device, the at least one electronic device, or the combination thereof.

2. The operating method for a system of an internet interactive service as claimed in claim 1, wherein the network host comprises a storage system and a recognition system.

3. The operating method for a system of an internet interactive service as claimed in claim 2, wherein the audio watermark in the step b is stored in the storage system.

4. The operating method for a system of an internet interactive service as claimed in claim 2, wherein the network host in the step f utilizes the recognition system to recognize the audio watermark or the certification transmitted by the at least one electronic device the same as the sound watermark transmitted from the network host to the at least one multimedia device.

5. The operating method for a system of an internet interactive service as claimed in claim 1, wherein the at least one datum in the step h is a text, a file, a video, an audio, multimedia, software for processing a specific work comprising video-editing software, audio-editing software, real-time communication software, motion sensing producing software, voting system software, advertising system software, an electronic game, teaching and research software, monitoring system software, payment system software, remote control system software, or the combination thereof.

6. The operating method for a system of an internet interactive service as claimed in claim 1, wherein computing architecture of the network host is centralized computing or distributed computing.

7. The operating method for a system of an internet interactive service as claimed in claim 1, wherein the network host is a pedestal server, a rack server, a mainframe computer, a super computer or a blade server.

8. The operating method for a system of an internet interactive service as claimed in claim 2, wherein a data storage device of the storage system is Redundant Array of Inexpensive Disks (RAID), Solid State Disk (SSD), Hard Disk Drive (HDD), a memory, a magnetic tape, Network Attached Storage (NAS), or the combination thereof.

9. The operating method for a system of an internet interactive service as claimed in claim 1, wherein the at least one multimedia device is a television, a smartphone, a computer or a tablet computer.

10. The operating method for a system of an internet interactive service as claimed in claim 1, wherein the at least one electronic device is a television, a smartphone, a computer or a tablet computer.

11. A system of an internet interactive service comprises:
at least one multimedia device comprising a first network interface, a multimedia device microprocessor and an audio broadcasting system, wherein the at least one multimedia device connected to internet via the first network interface, the multimedia device microprocessor connected with the first network interface, the audio broadcasting system connected with the multimedia device microprocessor, the audio broadcasting system broadcasting an audio watermark;
at least one electronic device comprising a third network interface, an electronic device microprocessor and an audio receiving system, wherein the at least one electronic device connected to internet via the third network interface, the electronic device microprocessor connected with the third network interface, the audio receiving system connected with the electronic device microprocessor, the audio receiving system receiving the audio watermark; and
a network host comprising a second network interface, a network host central processor, a storage system and a recognition system, wherein the second network interface connected with the network host central processor and the storage system, the second network interface connected to the first network interface of the at least one multimedia device and the third network interface of the at least one electronic device via internet, the storage system connected with the network host central processor and the second internet interface, the storage system storing at least one datum, the recognition system connected with the network host central processor, the recognition system comparing the audio watermark broadcast by the at least one multimedia device with the audio watermark received by the at least one electronic device;
the network host recognizing the audio watermark or certification transmitted by the at least one electronic device the same as the audio watermark transmitted from the network host to the at least one multimedia device, the network host setting the at least one multimedia device and the at least one electronic device as a specific group.

12. The system of an internet interactive service as claimed in claim 11, wherein the audio watermark is transmitted from the storage system of the network host via the second network interface to the at least one multimedia device.

13. The system of an internet interactive service as claimed in claim 11, wherein the audio broadcasting system is a speaker.

14. The system of an internet interactive service as claimed in claim 11, wherein the audio receiving system is a microphone or a receiving set.

15. The system of an internet interactive service as claimed in claim 11, wherein the at least one multimedia device is a television, a smartphone, a computer or a tablet computer.

16. The system of an internet interactive service as claimed in claim 11, wherein the at least one electronic device is a television, a smartphone, a computer or a tablet computer.

17. The system of an internet interactive service as claimed in claim 11, wherein the at least one datum is transmitted from the storage system of the network host via the second network interface to the specific group comprising the at least one multimedia device, the at least one electronic device, or the combination thereof.

18. The system of an internet interactive service as claimed in claim 11, wherein the at least one datum is the audio watermark, the certification, a text, a file, a video, an audio, multimedia, software for processing a specific work comprising video-editing software, audio-editing software, real-time communication software, motion sensing producing software, voting system software, advertising system software, an electronic game, teaching and research software, monitoring system software, payment system software, remote control system software, or the combination thereof.

19. The system of an internet interactive service as claimed in claim 11, wherein a data storage device of the storage system is Redundant Array of Inexpensive Disks (RAID), Solid State Disk (SSD), Hard Disk Drive (HDD), a memory, a magnetic tape, Network Attached Storage (NAS), or the combination thereof.

20. The system of an internet interactive service as claimed in claim 11, wherein computing architecture of the network host is centralized computing or distributed computing.

21. The system of an internet interactive service as claimed in claim 11, wherein the network host is a pedestal server, a rack server, a mainframe computer, a super computer or a blade server.
